(19) United States
(12) Patent Application Publication
(10) Pub. No.: US 2019/0219821 A1
(43) Pub. Date: Jul. 18, 2019

(54) OPTICAL SOURCE APPARATUS

(71) Applicant: MAXELL, LTD., Kyoto (JP)

(72) Inventors: Toshinori SUGIYAMA, Kyoto (JP); Koji HIRATA, Kyoto (JP); Masahiko YATSU, Kyoto (JP); Yasuhiko KUNII, Kyoto (JP)

(21) Appl. No.: 16/332,067

(22) PCT Filed: Mar. 28, 2017
(86) PCT No.: PCT/JP2017/012664

§ 371 Date: Mar. 11, 2019

(30) Foreign Application Priority Data
Sep. 12, 2016 (JP) 2016-177427

(51) Int. Cl. G02B 27/01; G02B 27/28; G02B 27/30; G02B 27/12

(52) U.S. Cl. CPC G02B 27/0101; G02B 27/123; G02B 27/30; G02B 27/28

(57) ABSTRACT

The present invention provides an optical source apparatus that can be manufactured with a low cost, is small and light in weight, has a high usage efficiency of emitted light, and is modularized to be easily usable as a planar optical source. The optical source apparatus includes at least: a plurality of semiconductor optical source elements configured to generate light; a collimator portion on each light emitting axis of the plurality of semiconductor optical source elements; and a polarization conversion element configured of a plurality of polarization split prisms and a phase plate, and the polarization split prisms and the phase plate are arranged at positions that are symmetric to each other with respect to a center axis of the collimator.

### TECHNICAL FIELD

The present invention relates to an optical source apparatus that is usable as a planar optical source using a solid light emitting element.

### BACKGROUND ART

Along with significant development of solid light emitting elements such as an LED in recent years, lighting devices using such a solid light emitting element as an optical source have been popularly used in various lighting apparatuses as optical sources each of which is small and light in weight and each has a low power consumption and a long life that is excellent in environmental conservation.

Conventionally, according to, for example, the following Patent Document, a semiconductor element optical source apparatus having a simple configuration has been already known as an optical source apparatus for a projector, the semiconductor element optical source apparatus effectively cooling a semiconductor light emitting element so as to brightly emit light.

### RELATED ART DOCUMENT

### Patent Document

Patent Document 1: Japanese Patent Application Laid-Open Publication No. 2016-33668

### SUMMARY OF THE INVENTION

### Problems to be Solved by the Invention

However, in the semiconductor optical source apparatus disclosed in the above-described related art (Patent Document 1), by mainly effectively cooling the semiconductor light emitting element, a semiconductor element optical source apparatus which prevents this element from being short-circuited and failing to function, and thus, which effectively and brightly emit the light is provided, and the semiconductor element optical source apparatus is configured so that light emitted from the semiconductor element is collected by using a single or a plurality of lenses facing this element. Therefore, in the related art, although a light emitting efficiency can be improved by an LED that is a semiconductor optical source, it is difficult to sufficiently collect and use the emitted light. Particularly, a projector, and besides, a head up display (hereinafter, referred to as “HUD”) device, a head rump device for vehicle and others required to offer a light emitting performance having a high amount of the light are still insufficient in optical usage efficiency characteristics and uniformed illumination characteristics, and have a room for various improvements.

Accordingly, the present invention provides an optical source apparatus which is small and light in weight, which has a high usage efficiency of the emitted light, and which is modularized so as to be easily used as a planar optical source. More specifically, an object of the present invention is to provide an optical source apparatus having more improved optical usage efficiency and uniformed illumination characteristics of a laser beam from an LED optical source, achieving downsizing and modularization of the optical source apparatus, and being suitable as an illumination optical source that can be manufactured with a low cost.

### Means for Solving the Problems

As one embodiment for achieving the above-described object, according to the present invention, an optical source apparatus is provided, the optical source apparatus including at least a semiconductor optical source element configured to generate light and a collimator portion arranged on a light emitting axis of the semiconductor optical source element so as to substantially cover alight emitting surface of the semiconductor optical source element, the collimator portion including a lens portion made of a light-transparent resin to be uniformed and configured to collect light emitted along the light emitting axis of the semiconductor optical source element and a reflector portion being away from the light emitting axis of the semiconductor optical source element and configured to peripherally collect the emitted light, and the light emitting side of the collimator portion having polarization conversion elements made of optical parts arranged to be symmetrical to each other on right and left sides with respect to a center axis of the collimator portion.

### Effects of the Invention

According to the present invention, such excellent effects as providing an optical source apparatus that can be manufactured with a low cost, is small and easily modularized, has high optical usage efficiency and low power consumption, and is excellent in environmental conservation, are obtained.

### BRIEF DESCRIPTIONS OF THE DRAWINGS

FIG. 1 is a developed perspective view showing an entire outline of a HUD device including an image display apparatus as one example of application of an optical source apparatus of the present invention;

FIG. 2 is a perspective view showing an outline of an internal configuration of the image display apparatus;

FIG. 3 is a perspective view showing one example of an internal (optical system) configuration of the optical source apparatus of the present invention;

FIG. 4 is a cross-sectional view showing a specific configuration of an LED collimator configuring the optical source apparatus;

FIG. 5 is a cross-sectional view showing a comparative example of the LED collimator configuring the optical source apparatus;

FIG. 6 is a cross-sectional view showing another example of the LED collimator configuring the optical source apparatus;

FIG. 7 is a cross-sectional view showing a comparative example of another example of the LED collimator configuring the optical source apparatus;

FIG. 8 is a top view and a side view for explaining occurrence behavior of polarization light in an optical source apparatus including a polarizing function;

FIG. 9 is an entire perspective view and a cross-sectional view including a partially-enlarged cross section of the perspective view for explaining details of a light guide configuring the optical source apparatus;

FIG. 10 is a side view for explaining a light guiding function of the light guide;

FIG. 11 is a perspective view showing an entire outline of still another example of an image display apparatus to which the optical source apparatus of the present invention is applied;

FIG. 12 is a top view and a side view for explaining the light guiding function in a configuration in which a light distribution plate is arranged in place of a synthesis diffusion block;

FIG. 13 is a top view and a side view for explaining another example of the optical source apparatus of the image display apparatus shown in FIG. 12;

FIG. 14 is a perspective view and a developed perspective view thereof showing an internal configuration of another example to which the optical source apparatus of the present invention is applied; and

FIG. 15 is a perspective view and a developed perspective view thereof showing an entire outline of another example to which the optical source apparatus of FIG. 14 is applied.

### BEST MODE FOR CARRYING OUT THE INVENTION

Hereinafter, embodiments of the present invention will be described in detail with reference to the accompanying drawings. Note that the same components are denoted by the same reference symbols in principle throughout all the drawings for describing the embodiments, and the repetitive description thereof will be omitted. Meanwhile, although portions explained with symbols in a certain diagram is not illustrated again when another diagram is explained, the portions with the same symbols are described in some cases.

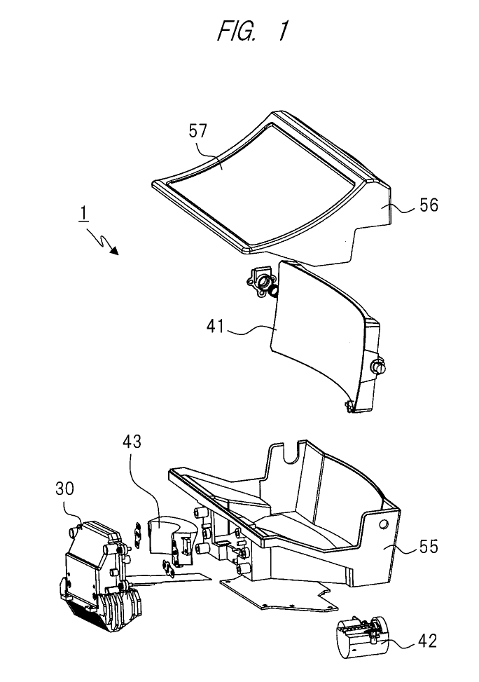

FIG. 1 shows an example in which an optical source apparatus according to the present invention described later is applied to a head up display (HUD) device as one example, an image display apparatus 30 including the optical source apparatus according to the present invention is attached to a part of an exterior case 55 that is an enclosure of the image display apparatus 30, a concave surface mirror 41, a distortion correcting lens 43 and others are housed inside the case. An opening through which imaging light is projected toward a windshield (not illustrated) is formed in an upper surface of an upper exterior case 57, and the opening is covered by an antidazzle plate (glare trap) 56. A symbol 42 in the drawing indicates a concave-surface mirror driving portion formed of an electric power motor for adjusting a position of the concave surface mirror 41.

In the HUD device 1 having such a configuration, it would be obvious to those who are skilled in the art that the imaging light emitted from the image display apparatus 30 is projected to a windshield of a vehicle (not illustrated) through a display distance adjusting mechanism, a mirror driving portion and others not illustrated here. By adjustment of a position at which the image is projected to the windshield by adjustment of an angle of the concave surface mirror 41, a display position of a virtual image what a driver is watching may be adjusted in up and down directions. Note that contents displayed as the virtual image are not particularly limited, and, for example, vehicle information, navigation information, a front scenery image captured as camera imaging (such as a monitoring camera and an around viewer) not illustrated or others can be suitable displayed.

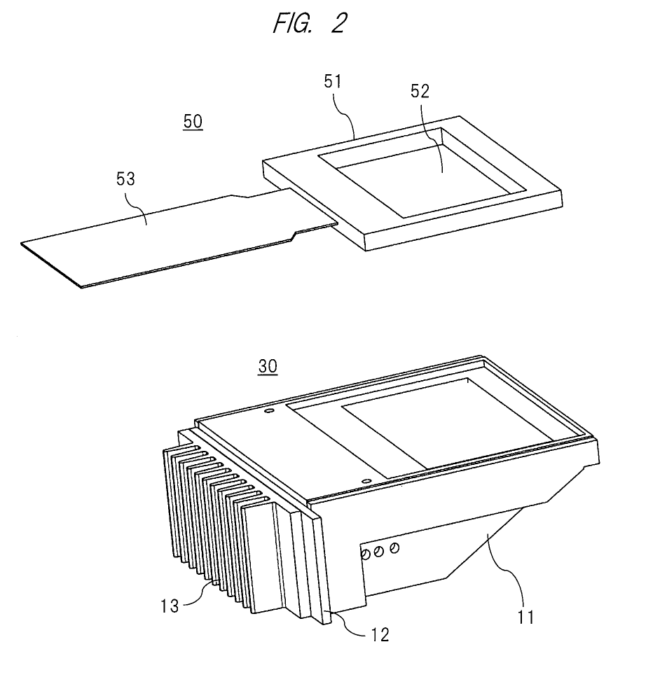

Subsequently, the image display apparatus 30 will be described in detail below with reference to FIG. 2. The image display apparatus 30 is configured so as to house an LED, a collimator, a polarization conversion element, a light guide and others that are also described later inside an optical source apparatus case 11 made of, for example, plastic or others. A liquid crystal display element 50 is attached to an upper surface of the image display apparatus 30, and an LED substrate 12 on which an LED (Light Emitting Diode) element that is a semiconductor optical source and a control circuit of the LED are mounted is attached to one side surface of the liquid crystal display element 50. Further, to an outer surface of the LED substrate 12, a heat sink (heat release fin) 13 for cooling heat generated in the LED element and the control circuit is attached.

In the image display apparatus 30, the liquid crystal display element 50 attached to the upper surface of the optical source apparatus case 11 includes a liquid crystal display panel frame 51, a liquid crystal display panel 52 attached to the frame, and a FPC (flexible printed circuit board) 53 electrically connected to the panel.

As clearly understood from the above description, for example, in the case of the HUD device, under such circumstances as a built-in configuration into a small space such as a dashboard of a vehicle, note that it is required for the image display apparatus 30 including the optical source apparatus of the present invention configuring the HUD device 1 to particularly be small, have high efficiency, and be suitably usable by modularization.

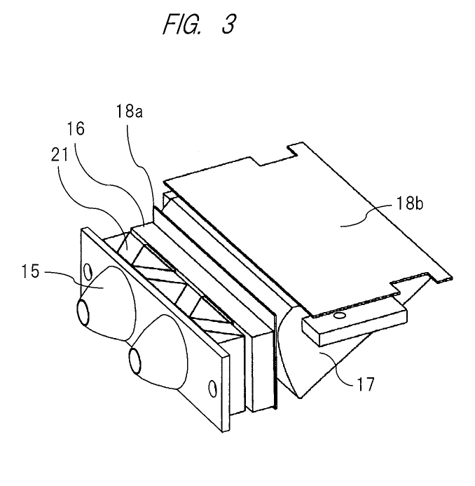

FIG. 3 shows a configuration of an optical system housed inside the image display apparatus 30, that is, inside the optical source apparatus case 11. That is, a plurality of (in this example, two) LED elements 14a and 14b (not illustrated her) configuring the optical source of the present invention are attached to the LED collimator 15 at predetermined positions.

On a light emitting side of the LED collimator 15, a polarization conversion element 21, that is made of optical members such as a phase plate and polarizing beam splitters that are arranged to be symmetric to each other in right and left directions with respect to a center axis of the LED collimator, is provided although described in detail later. Further, on a light emitting side of the polarization conversion element, a rectangular synthesis diffusion block 16 is provided. That is, laser beam emitted from the LED element 14a or 14b is converted to collimated light by a function of the LED collimator 15, and enters the synthesis diffusion block 16.

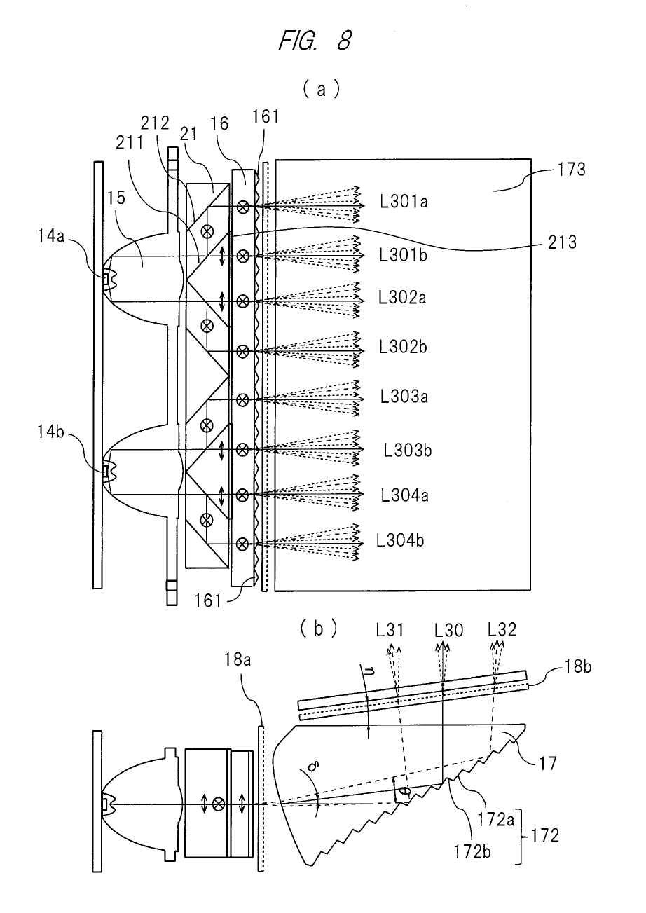

Further, as shown in FIG. 8 as one example, on a light emitting side of the synthesis diffusion block 16, a pyramid-shaped light guide 17 substantially having a triangular cross section is provided through a first diffuser 18a. To an upper surface of the light guide, a second diffuser 18b is attached. In this manner, the collimated light from the LED collimator 15 reflects upward in the drawing because of a function of the light guide 17, and is guided to an incident surface of the liquid crystal display element 50. At this time, note that intensities of the light are uniformed by the first and second diffusers 18a and 18b.

Subsequently, principal parts configuration the above-described optical source apparatus according to the present invention will be explained below together with details of the parts.

<Optical Source Apparatus>

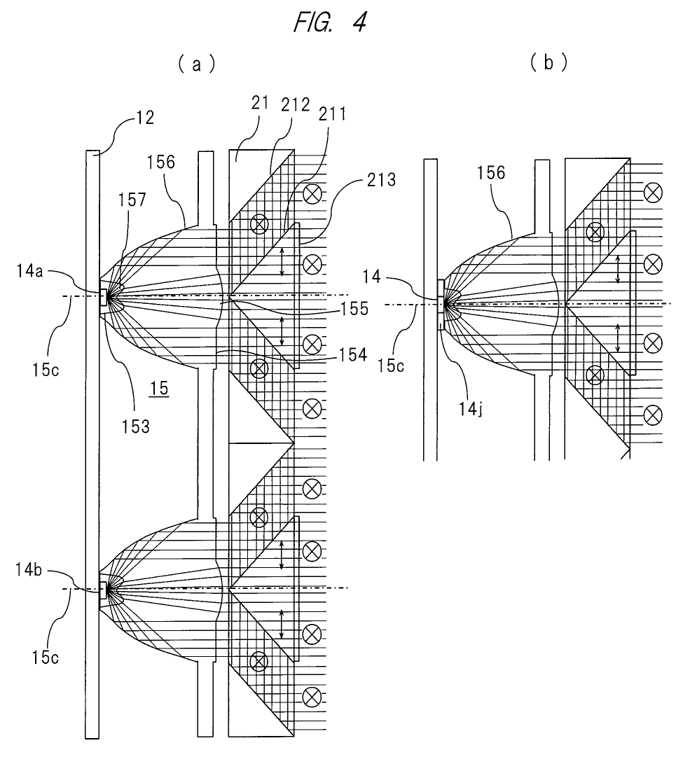

As shown in FIG. 4, the optical source apparatus according to the present invention includes the LED elements 14 (14a and 14b) that are a plurality of semiconductor light emitting elements formed on the LED substrate 12, and the LED collimator 15 that is arranged so as to face the light emitting surfaces of the elements. Note that the LED collimator 15 is made of, for example, a light-transparent resin such as polycarbonate, and is formed so as to surround peripheries of the LED elements 14 (14a and 14b) while centering the LED elements on the LED substrate 12 as shown in FIG. 4(a). More specifically, the LED collimator 15 has a conically-shaped outer circumference surface 156 that is substantially obtained by rotation of a parabolic cross section, has an apex on a light incident side at which a concave portion 153 having a predetermined curved surface is formed, and substantially has a center portion at which the LED elements 14 (14a and 14b) are arranged. Note that the parabolic surface (reflector portion) forming the conically-shaped outer circumference surface 156 of the LED collimator 15 is set so that light emitting from the LED elements 14a and 14b in a circumferential direction and entering inside of the LED collimator through air inside the concave portion 153 enters therein within a range of an angle at which the light totally reflects on the parabolic surface (outer circumferential surface) together with the curved surface of the concave portion 153. As shown in FIG. 4(b), an LED supporting body 14j is arranged outside of light emitting portions of the LED elements 14. When the LED supporting body 14j is larger than the concave portion 153, a tip of the outer circumferential surface 156 of the LED collimator 15 may be cut to have such a shape as avoiding interference from the LED supporting body 14j. When the total reflection on the parabolic surface is utilized as described above, a step of forming a metallic reflection film on the outer circumferential surface of the LED collimator or other steps is not required, and therefore, a less inexpensive device can be manufactured.

An incident surface (lens surface) 157 having a predetermined curved surface is formed at the center of the concave portion 153 of the LED collimator 15, and forms a convex lens having so-called light collecting function together with a convex portion (lens surface) 155 formed in a facing surface (emitting surface) 154. Note that this convex portion 155 may be formed in a plan or a concave lens surface that dents inward. That is, the center of the outline of the conical shape of the LED collimator 15 has a function of a light collecting lens that collects the light emitted from the LED collimator 15 toward the emitting surface side, and the outer circumferential surface 156 (reflector portion) of the LED collimator also has a function that collects the laser beam emitted in the circumferential direction from the LED element 14 and guides the laser beam toward the emitting surface side.

As shown in FIG. 4, in the LED substrate 12, note that each of the LED elements 14a and 14b on the surface of the LED collimator 15 is arranged and fixed at a position of the center of the convex portion 153. According to such a configuration, the laser beam emitted particularly from the center toward an emitted-light axis (in a right direction of the drawing) of the laser beam emitted from the LED element 14 is collected and converted to the collimated light by two convex lens surfaces 157 and 155 forming the outline of the LED collimator 15 in the LED collimator 15, and the laser beam emitted in the circumferential direction from other portions is reflected on the parabolic surface forming the conically-shaped outer circumferential surface (reflector portion) 156 of the LED collimator 15 and is similarly collected and converted to the collimated light. In other words, by the LED collimator 15 having the convex lens at the center and the parabolic surface formed at the circumferential portion, almost the entire laser beam generated by the LED element 14 can be extracted as the collimated light, so that the usage efficiency of the generated light can be improved.

Subsequently, the polarization conversion element 21 that is effective for achieving a high-efficiency optical source in the optical source using the liquid crystal display element will be explained.

As shown in FIG. 4, the polarization conversion element 21 is arranged on a back side of the emitting surface 154 of the LED collimator 15. The polarization conversion element 21 is configured so that a columnar (hereinafter, referred to as parallelogram columnar) light-transparent member having a parallelogram cross section extending in a direction perpendicular to a sheet of the drawing and a columnar (hereinafter, referred to as triangle columnar) light-transparent member having a triangular cross section are in a set, and a plurality of the sets are arranged in an array form in parallel to a surface that is orthogonal to the optical axis of the collimated light emitted from the LED collimator 15 (in this example, arranged in a direction along the sheet of the drawing), and so that the respective members are symmetrical to each other with respect to a center axis 15c or the LED collimator. Further, on an interface between these adjacent light-transparent members that are arranged in the array form, a polarizing beam splitter (hereinafter, abbreviated as “PBS”) film 211 and a reflection film 212 are alternately arranged. A “½λ” phase plate (half wave plate) 213 is formed on the emitting surface from which the light entering the polarization conversion element 21 and transmitting the PBS film 211 is emitted.

As described above, the polarization conversion element 21 has a structure having the optical members such as the PBS and the phase plate arranged to be symmetrical to each other in the right and left direction with respect to the surface (a vertical surface that vertically extends from the sheet of the drawing) formed by the optical axis of the collimated light from the LED collimator 15 and the extending direction of the parallelogram columnar light-transparent members, that is, with respect to the optical axis surface of the LED collimator. And, the polarization conversion element 21 configures a polarization conversion element that is divided into two sections in the vertical direction of the drawing for the collimated light from two LED collimators 15.

As clearly understood from FIGS. 4(a) and 4(b), by the polarization conversion element 21 configured as described above, for example, an S polarization wave (see a symbol (x) in the drawing) of the incident light that is emitted from the LED elements 14a and 14b to be the collimated light at the LED collimator 15 is reflected on the PBS film 211, and then, further reflected on the reflection film 212, and reaches the incident surface of the synthesis diffusion block 16. On the other hand, a P polarization wave thereof (see up and down arrows in the drawing) transmits the PBS film 211, and then, is converted to be an S polarization wave by the “½λ” phase plate 213, and reaches the incident surface of the synthesis diffusion block 16.

As described above, by the polarization conversion element 21, the entire light that is emitted from the (plurality of) LED (s) and converted to be the collimated light by the LED collimator 15 is converted to the S polarization wave, and enter the incident surface of the synthesis diffusion block 16.

Further, as described above, when the optical members such as the PBS and the phase plate are arranged to be symmetrical to each other with respect to the center axis of the LED collimator, the apparatus can be downsized.

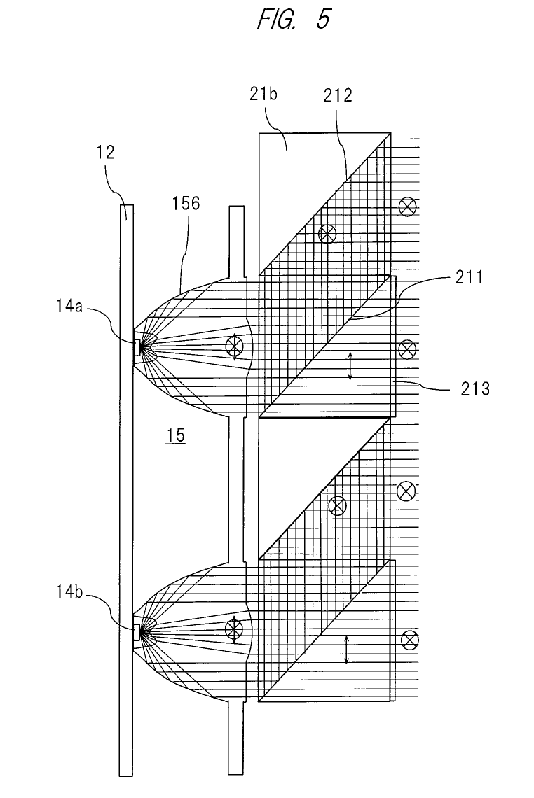

As a comparative example, a general arrangement example of the polarization conversion element 21b is shown in FIG. 5. The S polarization wave (see the symbol (x) in the drawing) of the incident light that is emitted from the LED elements 14a and 14b to be the collimated light at the LED collimator 15 is reflected on the PBS film 211, and then, further reflected on the reflection film 212, and reaches the incident surface of the synthesis diffusion block 16. On the other hand, the P polarization wave thereof (see the up and down arrows in the drawing) transmits the PBS film 211, and then, is converted to be the S polarization wave by the “½λ” phase plate 213, and reaches the incident surface of the synthesis diffusion block 16.

As described above, by the polarization conversion element 21b, the entire light that is emitted from the (plurality of) LED elements 14a and 14b and converted to be the collimated light by the LED collimator 15 is converted to the S polarization wave, and enters the incident surface of the synthesis diffusion block 16, and therefore, the high efficiency of the optical source using the liquid crystal display device can be achieved as similar to the configuration as shown in FIG. 4. However, a thickness of the polarization conversion element 21b is larger than that of the configuration as shown in FIG. 4, and therefore, the optical source apparatus cannot be downsized. Besides, by the large thickness of the polarization conversion element, an amount of a usage material is increased, and therefore, the low cost cannot be achieved. By the larger thickness of the polarization conversion element, difference in a light path length between a light flux reflected on the PBS film and a light flux transmitting it becomes larger. By the large light path length difference, difference in a light flux shape between them is easily caused. Particularly in a system using the plurality of optical sources and the LED collimator, it is difficult to achieve the luminance distribution uniformity due to the difference in the light flux shape.

Therefore, in the configuration required to be downsized as the HUD device and to uniform the luminance by using the plurality of LEDs, it is useful to adopt the configuration in which the plurality of optical members forming the polarization conversion element are arranged to be symmetrical to each other with respect to the center axis of each LED as shown in FIG. 4 to reduce the difference in the light path length between the light flux reflected on the PBS of the polarization conversion element and the light flux transmitting it.

Further, in order to achieve a high luminance and a wide viewing angle of the HUD device, high power of the LED optical source is desired. In order to achieve the high power of the LED optical source, a method of increasing the number of the LED optical sources or a method of increasing an area of the LED optical source is cited.

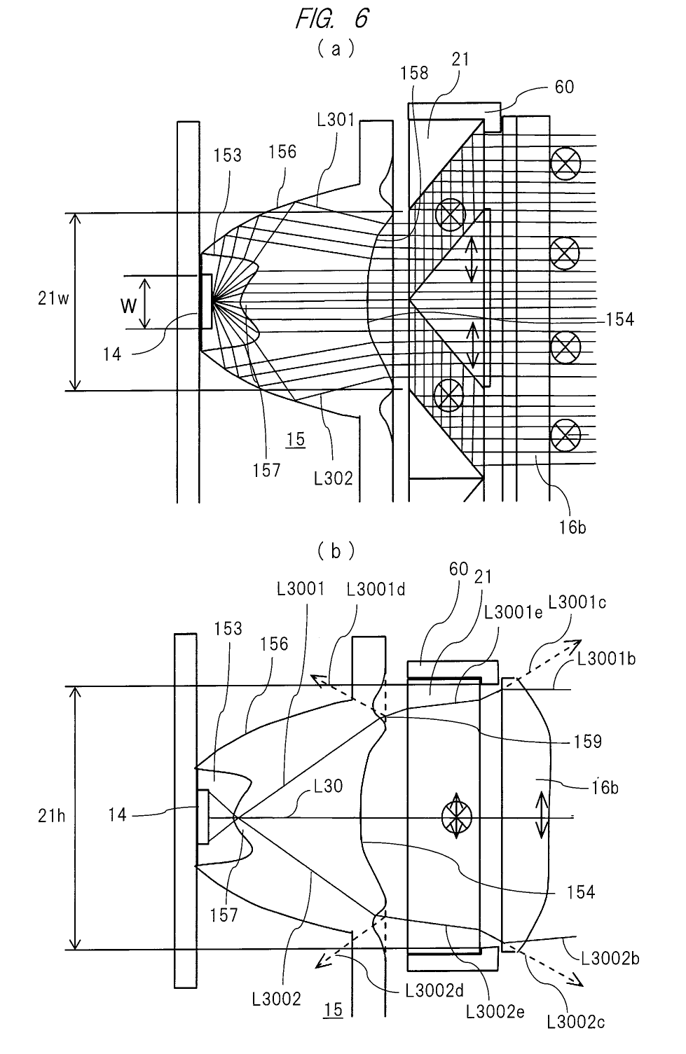

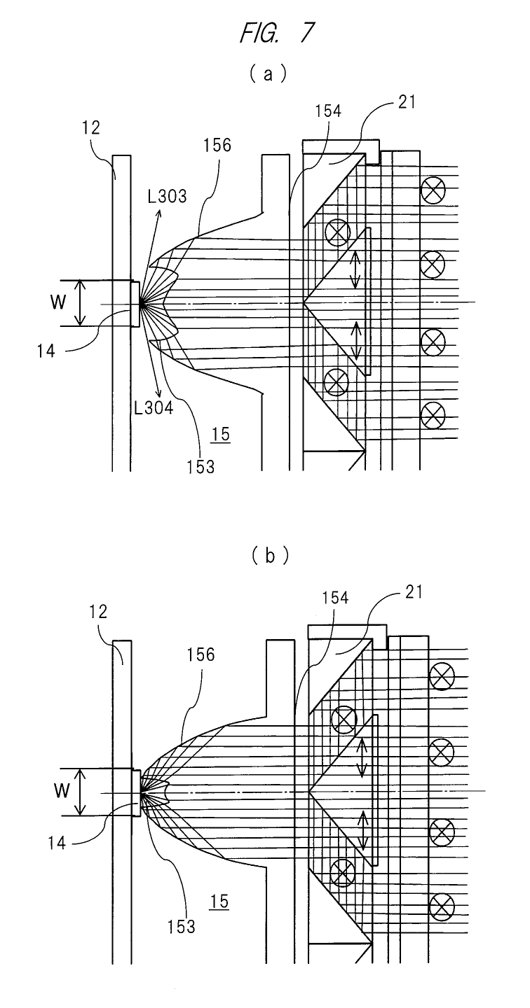

When a liquid crystal display device is used, a polarization conversion element that is effective for achieving the high efficiency of the optical source has a limitation width 21w of an incident light flux as shown in FIG. 6. As a result of the studies, it has been found that problems as shown in FIG. 7 occurs if a width W of the LED optical source in a direction of the limitation width 21w of the incident light flux is ¼ times the width 21w or larger when the emitting surface 154 of the LED collimator is flat. That is, as shown in FIG. 7 (a), if the shape of the concave portion 153 of the LED collimator 15 is formed to be larger than the LED optical source width W in order to secure an uptake amount of the light emitted from the LED optical source, light beams L303 and L304 each having a large divergent angle and emitted from the LED optical source cannot be taken due to the shape limitation of the outer circumferential surface 156 of the LED collimator 15, and therefore, the efficiency is reduced. On the other hand, as shown in FIG. 7 (b), if the shape is formed to be a shape by which the light beams L303 and L304 each having the large divergent angle can be taken, the concave portion 153 is smaller than the LED optical source width W, and a light beam (not illustrated) emitted from a peripheral portion of the LED cannot be taken, and therefore, the efficiency is reduced.

As a result of earnest studies, as shown in FIG. 6(a), it has been found that the concave surface 158 whose width is nearly the limitation width 21w of the incident light flux is formed inside the emitting surface 154 of the LED collimator 15, so that the shape of the outer circumferential surface 156 of the LED collimator 15 can be formed to be larger than the shape shown in FIG. 7(a), and therefore, the problems as descried above can be solved. That is, by the increase in the shape of the outer circumferential surface 156 of the LED collimator 15, the light reflected on the outer circumferential surface 156 slightly becomes the convergent light shown as light beams L301 and L302 of FIG. 6(a) but are slightly converted to be collimated and emit from the emitting surface 154, and therefore, the optical source apparatus having good efficiency and characteristics can be achieved.

A light beam that emits from the LED element 14 and refracts on a convex incident surface (lens surface) 157 of the LED collimator 15 will be explained with reference to FIG. 6(b) showing the shape of FIG. 6(a) viewed from the vertical direction with respect to the sheet of the drawing. Light L30 emitted from the center of the LED element 14 is converted to be substantially the collimated light at the incident surface of the LED collimator because the incident surface has the convex lens shape, and reaches the emitting surface 154. Meanwhile, in consideration of a light beam L3001 and a light beam L3002 that emit from an end of the LED element 14 and cross particularly at a center axis, the light beams enter at an angle close to a vertical angle with respect to the convex incident surface 157 of the LED collimator, and therefore, proceed to the outer circumferential portion of the emitting surface 154 of the LED collimator because refraction angles of the light beams are small.

In a direction shown in FIG. 6(b), note that the incident-light-flux limitation width of the polarization conversion element becomes an opening height 21h of a polarization conversion element holder 60. In this example, a convex lens shape portion 159 is formed in the outer circumferential portion of the emitting surface 154 of the LED collimator 15 as shown in the drawing, the light transmits a surface of the convex lens shape portion and enters a next optical element (such as the synthesis diffusion block, the polarization conversion element 21 or others). Here, if the outer circumferential portion of the emitting surface 154 of the LED collimator does not have the convex lens shape portion 159 but is flat (see a broken line portion in vicinity of the convex lens shape portion 159 in the drawing), light beams L3001d and L3002d significantly refract on the surface (although not illustrated) or totally reflect thereon as shown with a broken-line arrow in the drawing. That is, the light beams cannot be effectively utilized, and therefore, the usage efficiency of the light is reduced.

As described above, by the above-described LED collimator 15, not only the light emitted along the emitting optical axis among the light emitted from the LED element 14 but also the light emitted in the circumferential direction can be collected and guided toward the emitting surface side, and therefore, the optical source apparatus having the high usage efficiency of the emitted light and being modularized so as to be conveniently usable as a planar optical source can be provided, more specifically, the light usage efficiency and the uniformed illumination characteristics of the laser beam from the LED optical source are improved, that achieves the downsizing and the modularization of the optical source apparatus, and that can be manufactured with a low cost and is suitable as an illumination optical source can be provided. Note that symbols 21 and 60 in FIGS. 6(a) and 6(b) indicate the polarization conversion element and the holder for this element described later, respectively, and a symbol 16b indicates the light distribution plate also described later. Each propagation direction of light beams L3001c, L3002C, L3001d and L3002d inside these portions are shown with arrows in the drawing.

<Synthesis Diffusion Block and Diffuser>

Subsequently, the synthesis diffusion block 16 that is still another component of the image display apparatus 30 will be explained with reference to FIG. 8.

A large number of textures 161 each substantially having a triangular cross section are formed in an emitting surface of a prismatic synthesis diffusion block 16 made of a light-transparent resin such as acrylic resin as clearly understood from FIG. 8(a), and the light emitted from the LED collimator 15 is diffused in a vertical direction of an incident portion (surface) 171 of a light guide 17 described later by a function of these textures 161. By interaction between the substantially-triangular textures 161 and diffusers 18a and 18b described later, the intensity distribution of the light emitted from the emitting portion 173 of the light guide 17 can be uniformed even when the LED collimator 15 is discretely arranged.

Particularly, by the above-described textures 161, the diffusion direction can be limited to a direction of a side surface of the light guide, and the diffuseness in the side surface direction can be controlled, and therefore, the isotropic diffuseness of the first and second diffusers 18a and 18b can be weakened. As a result, the light usage efficiency can be improved, and the optical source apparatus having good characteristics can be achieved. Note that this example shows that an angle “y”=30 degrees and a formation pitch “a”=0.5 mm as one example of the substantially-triangular textures 161.

<Light Guide>

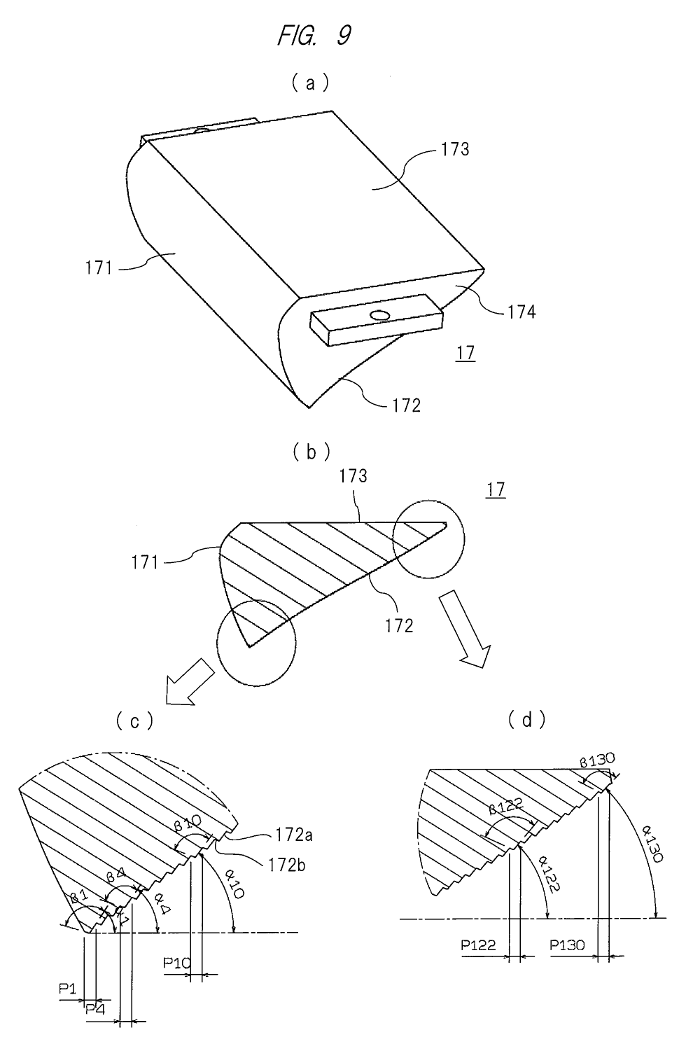

Subsequently, details of the light guide 17 configuring the image display apparatus 30 will be explained below with reference to FIG. 9. Note that the light guide 17 has a function of guiding the light taken as the collimated light from the optical source apparatus toward a desirable direction and taking out the light as planar light having a desirable area.

FIG. 9(a) is a perspective view showing the entire light guide 17, FIG. 9(b) is a cross section of the light guide, and each of FIGS. 9(c) and (d) is a partial enlarged cross-sectional view showing details of the cross section.

The light guide 17 is, for example, a bar-shaped member substantially having a triangular cross section (see FIG. 9 (b)) made of a light-transparent resin such as acrylic resin. As clearly understood from FIG. 9(a), the light guide 17 includes a light-guide light incident portion (surface) 171 facing the emitting surface of the synthesis diffusion block 16 through the first diffuser 18a, a light-guide light reflection portion (surface) 172 forming an oblique surface, and a light-guide light emitting portion (surface) 173 facing a liquid crystal display panel 52 of the liquid crystal display element 50 through the second diffuser 18b.

On the light-guide light reflection portion (surface) 172 of the light guide 17, a large number of reflection surfaces 172a and junction surfaces 172b are alternately formed in a saw teeth form as shown in FIGS. 9(c) and (d) that are partial enlarged views of the light-guide light reflection portion. Each of the reflection surfaces 172a (a positively-sloped line component in the drawing) forms “αn” (“n”: natural number is, for example, 1 to 130 in this case) with respect to a horizontal surface shown with a chain line in the drawing. Here, as one example of this, “αn” is set to be equal to or smaller than 43 degrees (but equal to or larger than 0 degree).

On the other hand, each of the junction surfaces 172b (a negatively-sloped line component in the drawing) forms “βn” (“n”: natural number is, for example, 1 to 130 in this case) with respect to the horizontal surface. That is, the junction surface 172b of the reflection portion is tilted with respect to the incident light by an angle at which shadow is caused in a range of a half-value angle of a scatter described later. Although described in detail later, each of α1, α2, α3, α4, . . . forms a reflection-surface elevation angle, and each of β1, β2, β, β4, . . . forms a relative angle between the reflection surface and the junction surface. As one example, 90 degrees or larger (but equal to or smaller than 180 degrees) is set. In this example, β1=β2=β3=β4= . . . =β122= . . . β130.

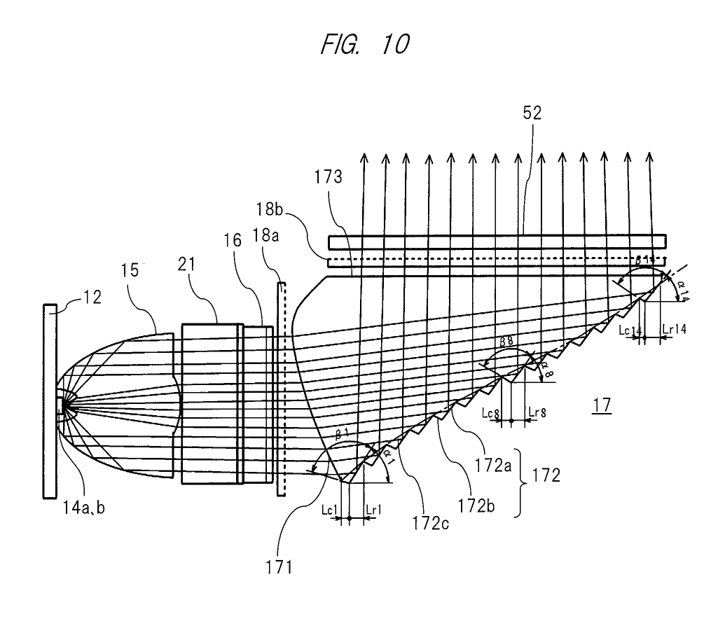

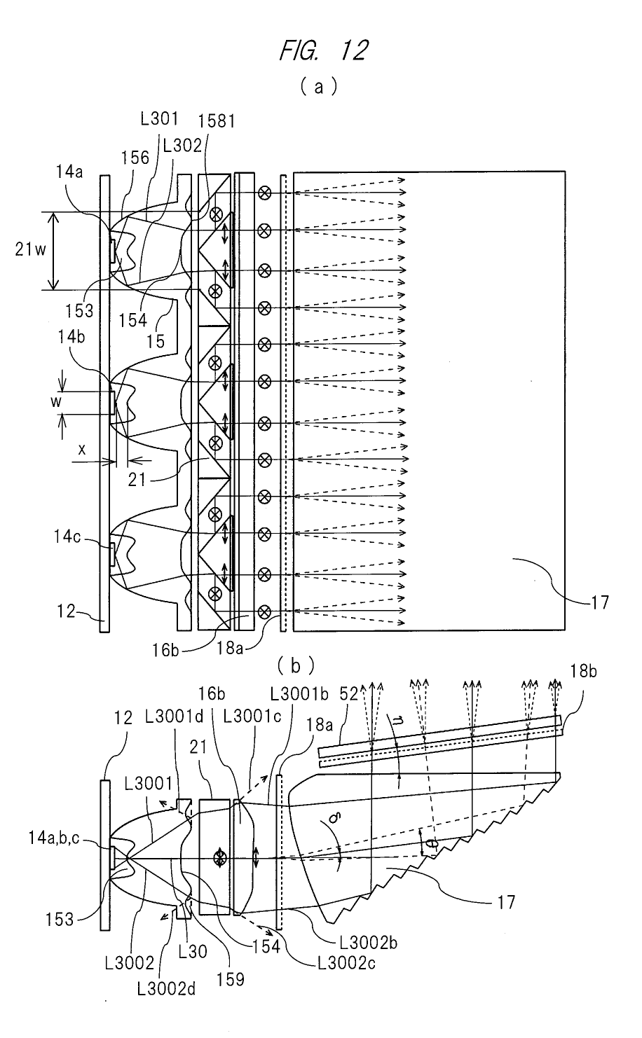

FIG. 10 shows a schematic view in which the reflection surface 172a and the junction surface 172b are larger in a size than the light guide 17 for explanation. On the light-guide light incident portion (surface) 171 of the light guide 17, a principal light beam is polarized by “δ” in a direction that causes a larger incident angle with respect to the reflection surface 172a (see FIG. 12(b)). That is, the light-guide light incident portion (surface) 171 is formed into a curved convex shape that is tilted toward the optical source side. Because of this shape, the collimated light emitted from the emitting surface of the synthesis diffusion block 16 is diffused and enters through the first diffuser 18a, and reaches the light-guide light reflection portion (surface) 172 while slightly bending (deflecting) upward by the light-guide light incident portion (surface) 171.

Note that the large number of reflection surfaces 172a and junction surfaces 172b are alternately formed in a saw teeth form on the light-guide light reflection portion (surface) 172, so that the diffusion light totally reflects on each of the reflection surfaces 172a and goes upward, and enters the liquid crystal display panel 52 as the collimated diffusion light through the light-guide light emitting portion (surface) 173 and the second diffuser 18b. Therefore, the reflection-surface elevation angles α1, α2, α3, α4, . . . are set so that each of the reflection surfaces 172a makes an angle that is equal to or larger than an optimum angle from the diffusion light. On the other hand, each of the relative angles β1, β2, β3, β4, . . . between the reflection surfaces 172a and the junction surfaces 172b is set to a certain angle as described above, more preferably set to the angle that is equal to or larger than 90 degrees (βn≥90°).

By the above-described configuration, each of the reflection surfaces 172a is configured to always make the angle that is equal to or larger than the optimum angle from the diffusion light. Therefore, even if the reflection film made of metal or others is not formed in the light-guide light reflection portion (surface) 172, the total reflection is achieved, so that the optical source apparatus that is manufactured with a low cost and that includes the light guide having the function of guiding the light in a desirable direction and taking out the light as the planar light having a desirable area can be achieved.

By the shape of the light-guide light reflection portion (surface) 172 of the light guide 17, conditions for the total reflection of the principal light can be satisfied, and therefore, it is not required to form the reflection film made of aluminum or others in the light-guide light reflection portion (surface) 172, the light can be effectively reflected, and it is not required to perform a deposition work for the aluminum thin film resulting in the increase in the manufacturing cost, either, so that a lower-cost and brighter optical source can be achieved. Each of the relative angles β1, β2, β3, β4, . . . is set to an angle at which the junction surface 172b is shaded from the light formed by the diffusion of the principal light beam 30 on the synthesis diffusion block 16 and the diffuser 18a. In this manner, the unnecessary light entering to the junction surface 172b is suppressed, so that the unnecessary light reflection is reduced, and therefore, the optical source apparatus having the good characteristics can be achieved.

According to the above-described light guide 17, particularly when each of the reflection-surface elevation angles α1, α2, α3, α4, . . . is appropriately set, the length of the light-guide light emitting portion (surface) 173 in the optical axis direction can be freely changed. Therefore, the optical source apparatus that can change the size (area size) of the light-guide light emitting portion (surface) 173 to an appropriately-required size (area size) fitted with the device such as the liquid crystal display panel 52 on the basis of the light-guide light incident portion (surface) 171 can be achieved. In this point, the light-guide light emitting portion (surface) 173 can be shaped into a desirable shape without depending on the arrangement forms of the LED elements 14a and 14b configuring the optical source, so that the planar optical source having a desirable shape can be obtained. This point leads to securement for a degree of freedom in design including the arrangements of the LED elements 14a and 14b configuring the optical source, and therefore, this would be advantageous for the downsizing of the entire apparatus.

<Application Example of Optical Source Apparatus>

FIGS. 2 and 3 described above have exemplified the application of the optical source apparatus according to the present invention to the head up display (HUD) device 1. The following is explanations for other modification examples.

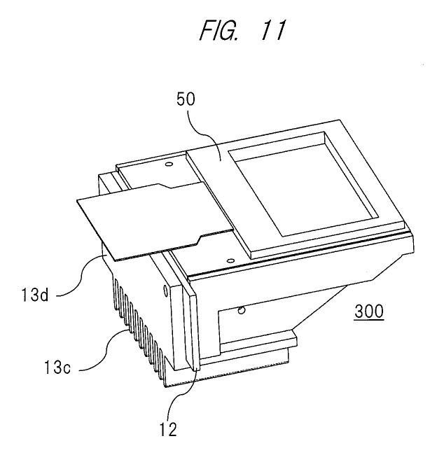

Although not described in detail, an example shown in FIG. 11 provides a configuration in which heat generated in the LED substrate 12 is cooled by a heat sink (heat release fin) 13c arranged below the apparatus through a heat transfer plate 13d. According to the present configuration, note that an optical source apparatus having a short entire length can be achieved.

Further, in the above-described image display device in FIG. 12, the number of LED elements 14a, 14b and 14c configuring the optical source is set to be three, the respective LED collimators 15 are formed to be a continuously-joined united component, and the polarization conversion element 21 is provided between the respective LED collimators and the synthesis diffusion block 16. Further, the drawing shows a configuration of arrangement of a light distribution plate 16b in place of the synthesis diffusion block configuring the light distribution plate. The present configuration has a feature using a larger LED element 14 than the shape of the LED collimator 15 as shown in FIG. 6. Along with this, the shape of the incident portion (concave portion) 153 of the LED collimator 15 is a larger shape than those of other examples.

In explanation using FIG. 12 (a), the light L301 and the light L302 emitted in an oblique direction from the LED element 14a enter from the incident portion (concave portion) 153 of the LED collimator, reflects on the outer circumferential surface 156 of the incident portion so as to be slightly the convergent light, and reaches the emitting surface 154 of the LED collimator. The emitting surface 154, particularly, a slightly-peripheral portion 1581 of the emitting surface of the LED collimator 15 has a concave surface shape, and therefore, the light L301 and the light L302 refract on this portion, are converted to be almost collimated, and enter the light incident portion of the polarization conversion element 21. By the application of the present configuration, the light from the LED can effectively enter the polarization conversion element even when the width 21w of the light incident portion of the polarization conversion element is narrow as shown in FIG. 12(a), so that a high-efficiency optical source can be achieved.

Subsequently, a light beam that emits from the LED elements 14a, 14b and 14c and refracts on the convex incident surface 153 of the LED collimator 15 will be explained with reference to FIG. 12(b). The light L30 emitted from centers of the LED elements 14a, 14b and 14c is converted into substantially collimated light on the incident surface 153 of the LED collimator 15 because of having the convex shape, goes through the polarization conversion element 21 and through the diffuser 18a, the light guide 17 and the diffuser 18b, and enter the liquid crystal display panel 52. On the other hand, in consideration of a light beam L3001 and a light beam L3002 that emit from ends of the LED elements 14a, 14b and 14c and cross particularly at a center axis, the light beams enter at an angle that is nearly perpendicular to the incident surface 153 of the LED collimator 15, and therefore, each refraction angle of the light beams is small, and the light beams go to the peripheral portion of the emitting surface 154 of the LED collimator.

As shown in the drawing, the light beams transmit a surface of a convex lens shaped portion 159 formed in the peripheral portion of the emitting surface 154 of the LED collimator 15, transmit the polarization conversion element 21, and then, go through the light distribution plate 16b, and through the diffuser 18a, the light guide 17 and the diffuser 18b as shown in light L3001b and light L3002b, and enter the liquid crystal display panel 52.

In this case, if the shape of the outer circumferential portion 159 of the emitting surface 154 of the LED collimator 15 is not convex but flat, the light undesirably significantly refracts (not illustrated) or totally reflects as illustrated in the drawing on the surface as shown in light L3001d and light L3002d, and therefore, the efficiency is reduced. If the light distribution plate 16b is not arranged, the light goes away from the light incident portion of the light guide 17 as shown in light L3001c and light L3002c, and therefore, the light beam cannot be effectively utilized, and the efficiency is similarly reduced.

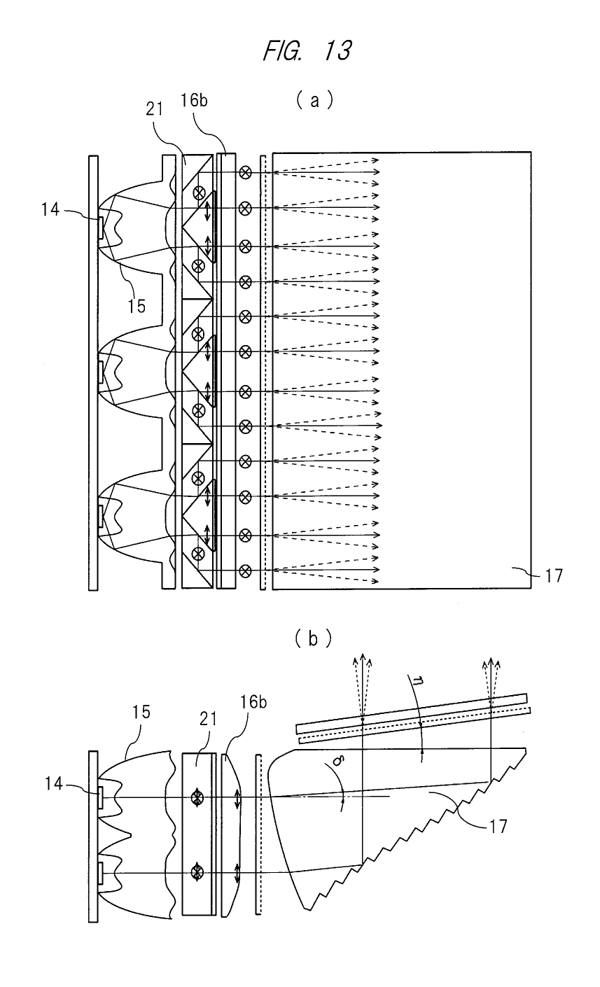

FIG. 13 shows an example of arrangement in which a row of three LED elements 14 is further added to the configuration shown in FIG. 12, that is, arrangement of “3×2=6” LED elements and LED collimators. Note that six LED collimators corresponding to the six LED elements are formed to be a continuously-connected uniformed component as similar to the above description. In consideration of manufacturing convenience of the polarization conversion element and others, it is desirable to arrange the plurality of LED elements and LED collimators in a square form.

In the present example, by the increase in the number of LED elements that are the optical sources, a brighter optical source apparatus or an optical source apparatus having a wider light-emitting area can be achieved. Note that the number of rows of the LED elements 14 is not limited to two. By more increase in the number of rows, a much brighter optical source apparatus and/or an optical source apparatus having a much wider light-emitting area can be obtained. According to the above-described configuration, for example, by control for alight emitting amount of the plurality of LED elements by the arrangement of the LED elements, it would be easy to achieve so-called local dimming or others.

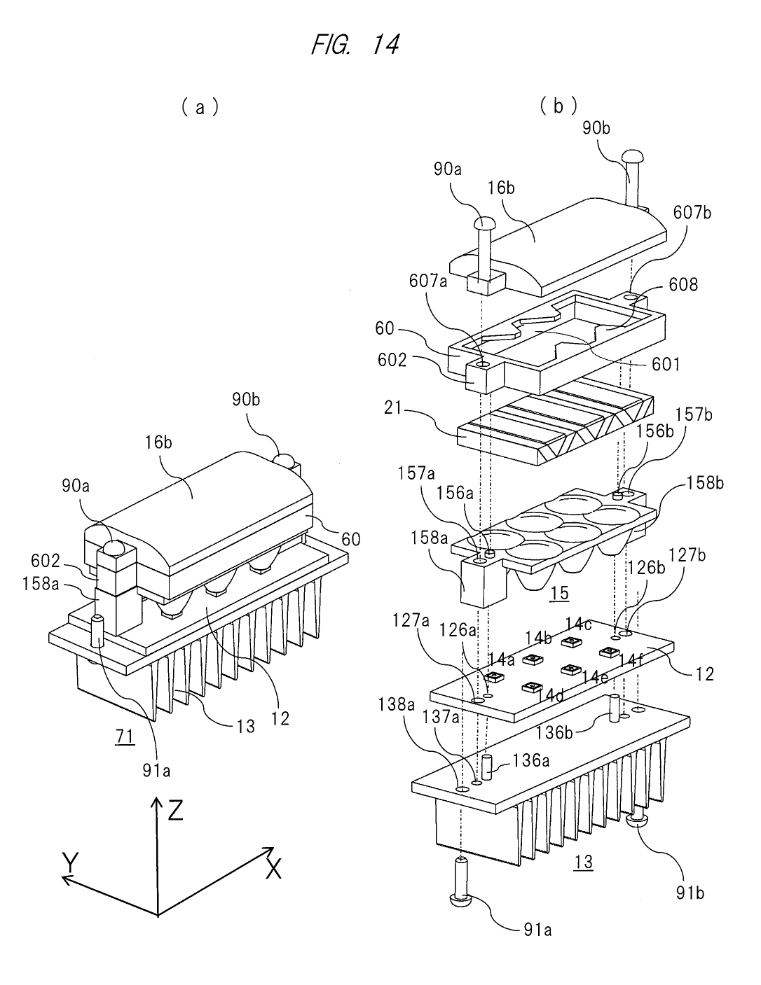

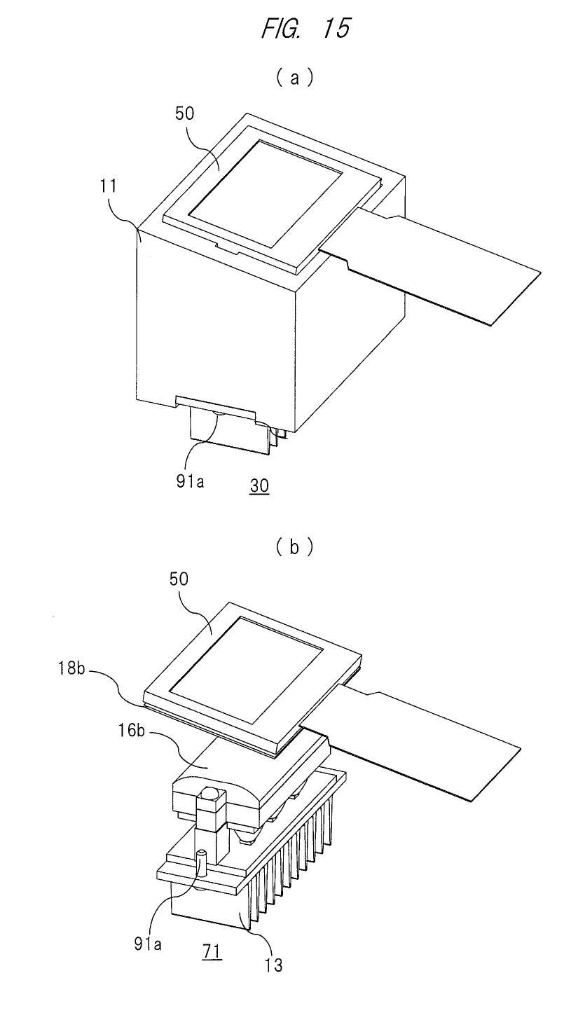

The optical source apparatus according to the present invention is not limited to one having an illumination optical system using the light guide as variously described above, and can be utilized in a directly lighting optical system. That is, as one example, FIGS. 14 and 15 show an example of an optical source apparatus using the light from the LED element that is collected by the LED collimator without using the light guide.

FIGS. 14(a) and 14(b) are a perspective view and a developed view of an entire configuration of an unitized optical source apparatus having the polarization conversion element 21 in addition to a plurality of (in this example, six) LED elements 14a, 14b, 14c, 14d, 14e and 14f, the LED collimator 15, and the light distribution plate 16b. As clearly understood from the drawings, the LED collimator 15 is formed so that a plurality of LED collimator parts are continuously connected and united as similar to the above description, and the LED substrate 12 on which this LED collimator 15 and the LED elements 14a, 14b, 14c, 14d, 14e and 14f are mounted is fitted to positioning pins 136a and 136b formed on the heat sink (heat release fin) 13, a positioning hole (not illustrated) formed on the LED collimator 15, and positioning holes 126a and 126b formed on the LED substrate 12, so that the LED substrate is positioned in X and Y directions in the drawings. At the same time, the LED substrate 12 abuts on attachment portions 158a and 158b of the LED collimator 15, so that the LED substrate is positioned in a Z direction.

The polarization conversation element 21 is housed inside a polarization conversion element holder 60, and is positioned by a step portion 601 formed inside the holder. Further, the polarization conversation element 21 is positioned by the fitting of convex portions 156a and 156b formed on the LED collimator 15 and a concave portion (not illustrated) formed on a back surface of the polarization conversion element holder 60. On an emitting side of the polarization conversion element holder 60, a light shielding portion 608 for shielding a part of light flux reflected on the PBS film 211 (see FIG. 4) of the polarization conversation element 21 may be arranged. Since an optical path is larger in the reflected light flux on the PBS film than the transmitted light flux through the film because of an element structure, the light fluxes tend to diffuse more, and therefore, it is desirable to shield a part of the light flux in some cases in order to achieve the uniformity of the luminance.

Bolts 90a and 90b are inserted into holes (not illustrated) formed in the light distribution plate 16b, and all the polarization conversion element holder 60, the LED collimator 15 and the LED substrate 12 are fixed onto the heat sink (heat release fin) 13, so that an optical source unit 71 that is the united optical source apparatus is completed. Inside this optical source unit 71, note that the LED substrate 12 and the LED collimator 15 that are required most to have the relative positioning accuracy are positioned by the fitting of the positioning pins 136a and 136b with the positioning hole (not illustrated) and the abutting of LED-collimator attachment portions 158a and 158b onto the LED substrate 12, and therefore, the accurate positioning is achieved. Note that it would be obvious to those who skilled in the art that the unitized configuration shown in FIG. 14 is the configuration that is also applicable to an optical source using the light guide shown in the drawings earlier than FIG. 14.

In the above-described optical source apparatus, as clearly seen from the drawings, note that the light emitted from the LED elements 14a, 14b, 14c, 14d, 14e and 14f that are the optical sources is collected and converted to the collimated light by the LED collimator 15, and converted to a predetermined S or P polarization light by the polarization conversion element 21, and then, emits from the light distribution plate 16b. If the polarization conversion is unnecessary, note that it would be obvious not to arrange the polarization conversion element 21.

As an example, FIG. 15 shows a mode using the above-described optical source apparatus as an optical source of the image display apparatus 30 configuring the HUD device described also in the above-described examples. As clearly seen from FIG. 15(a), the image display apparatus 30 is housed inside the optical source apparatus case 11 while exposing the heat sink (heat release fin) 13 to outside. Also, as clearly seen from FIG. 15(b), inside the optical source apparatus case 11, the liquid crystal display element 50 is arranged above the light distribution plate 16b configuring the optical source apparatus. The light emitted and collected from the plurality of LED elements that are the optical sources is converted to the S or P polarization light if needed, and then, and emits upward from the light distribution plate 16b to the liquid crystal display element 50, so that the imaging light of the image display apparatus 30 is obtained. In order to achieve the accurate light distribution, the emitting surface of the light distribution plate is formed to be substantially nearly a cylindrical surface. However, in order to achieve the more accurate light distribution, as shown in FIG. 15(B), a center of an edge portion has been formed to slightly have a concave shape, and a peripheral portion thereof has been formed to have a convex shape. That is, when so-called aspherical surface shape or free-from surface shape is applied to at least one surface of the light distribution pate, the more accurate light distribution is achieved. Note that FIG. 15 (b) shows the configuration using one light distribution plate. However, the present invention is not limited to this, and accurate and complex light distribution can be achieved by a configuration using a plurality of light distribution plates.

According to the configuration, note that the large number of the LED elements that are the optical sources can be arranged, and therefore, a brighter optical source apparatus can be achieved. And, the light emitting surface can be enlarged more, so that this configuration is preferable for a usage case as an optical source apparatus including a light emitting surface having a wide display area or a usage case in combination with a liquid crystal display panel having a wide display area. Also, according to the configuration, the emitting surface of the laser beam is divided into a plurality of display areas corresponding to a single or a plurality of LED elements, and a light emitting power (lighting) of the LED element(s) is, for example, independently controlled, so that so-called local dimming is achieved, and besides, high contrast of a display picture and reduction of power consumption are achieved.

In addition to the local dimming by the above-described individual LED control, by control of the liquid crystal display panel together with the individual LED element control by usage of the control substrate (not illustrated), a more favorable and lower power consumption optical source apparatus may be achieved, and besides, a vehicle head light device using this optical source apparatus may be achieved.

Further, it has been explained above that the liquid crystal display panel has the excellent transmittance to the S polarization wave. However, also in a case of an excellent transmittance to the P polarization wave, it would be obvious to those who skilled in the art that the similar functions and effects are obtained by the polarization conversion element having the configuration similar to that descried above.

The optical source apparatus according to various examples of the present invention has been described above. However, the present invention is not limited to only the above-described examples, and includes various modification examples. For example, in the above-described embodiments, the entire system has been explained in detail for easily explaining the present invention, and is not always limited to the one including all structures explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

### EXPLANATION OF REFERENCE CHARACTERS

11 . . . optical source apparatus case, 50 . . . liquid crystal display element, 12 . . . LED substrate, 13 . . . heat sink (heat release fin), 14 and 14a to 14f . . . LED element, 15 . . . LED collimator, 151 . . . outer circumferential surface (reflector portion), 153 . . . incident portion (concave portion), 154 . . . emitting surface, 155 . . . lens surface on emitting side, 156 . . . convex portion, 16 . . . synthesis diffusion block, 16b . . . light distribution plate, 17 . . . light guide, 171 . . . light-guide light incident portion (surface), 172 . . . light-guide light reflection portion (surface), 172a . . . reflection surface, 172b . . . junction surface, 173 . . . light-guide light emitting portion (surface), 18a and 18b . . . diffuser, 21 . . . polarization conversion element, 211 . . . PBS film, 212 . . . reflection film, 213 . . . ½λ phase plate (hale wave plate)

1. An optical source apparatus comprising at least:
a semiconductor optical source element configured to generate light; and
a collimator portion on a light emitting axis of the semiconductor optical source element,
wherein the collimator portion includes: a united lens portion made of a light-transparent resin and configured to collect light emitted along vicinity of the light emitting axis of the semiconductor optical source element; and a reflector portion configured to collect the emitted light to a peripheral position away from the light emitting axis of the semiconductor optical source element.

2. The optical source apparatus according to claim 1, further comprising
a plurality of semiconductor optical source elements;
a collimator portion arranged on each light emitting axis of the semiconductor optical source elements; and
a polarization conversion element configured of a plurality of polarization beam splitters and a phase plate,
wherein the polarization beam splitters and the phase plate are arranged at positions that are symmetric to each other with respect to a center axis of the collimator portion.

3. The optical source apparatus according to claim 2,
wherein at least a part of an emitting surface of the collimator portion, the part corresponding to a part inside an incident light flux width of the polarization conversion element, partially has a concave surface.

4. The optical source apparatus according to claim 3,
wherein a diameter of the reflector portion of the collimator portion is larger than the incident light flux width of the polarization conversion element.

5. The optical source apparatus according to claim 3,
wherein a convex portion for preventing total reflection is formed in an outer circumferential portion of the emitting surface of the collimator portion.

6. The optical source apparatus according to claim 3,
wherein each of the plurality of semiconductor optical source elements is an LED, and an LED size of the polarization conversion element in a direction of the incident light flux width is ¼ times the incident width of the polarization conversion element or larger.

7. The optical source apparatus according to claim 2,
wherein a plurality of the semiconductor optical source elements are arranged on the same substrate, and
a plurality of the collimators are provided so as to correspond to the plurality of semiconductor optical source elements, respectively, and are formed to be united.

8. The optical source apparatus according to claim 7,
wherein a synthesis diffusion block configured to synthesize and diffuse light from the plurality of collimator portions is formed on a light emitting surface side of the plurality of collimator portions.

9. The optical source apparatus according to claim 7,
wherein a light shielding portion configured to selectively shield a part of a light flux reflected on a polarization beam splitter of the polarization conversion element is formed on an emitting side of the polarization conversion element.

10. The optical source apparatus according to claim 8,
wherein a light guide configured to guide light from the synthesis diffusion block in a predetermined direction is further formed on a light emitting surface side of the synthesis diffusion block.

11. The optical source apparatus according to claim 7,
wherein a light distribution plate configured to guide light in a predetermined direction is formed on light emitting surface sides of the plurality of collimator portions.

12. The optical source apparatus according to claim 11,
wherein at least one surface of the light distribution plate is either an aspherical surface or a free-form surface.
